(19) United States
(12) Patent Application Publication
(10) Pub. No.: US 2025/0197579 A1
(43) Pub. Date: Jun. 19, 2025

(54) PROCESS FOR PRODUCING POROUS MATERIALS

(71) Applicant: aerogel-it GmbH, Osnabrueck (DE)

(72) Inventors: Raman Subrahmanyam, Osnabrueck (DE); Marc Fricke, Osnabrueck (DE); Dirk Weinrich, Osnabrueck (DE)

(73) Assignee: aerogel-it GmbH, Osnabrueck (DE)

(21) Appl. No.: 18/842,066

(22) PCT Filed: Mar. 8, 2023
(86) PCT No.: PCT/EP2023/055870

§ 371 Date: Aug. 28, 2024

(30) Foreign Application Priority Data
Mar. 8, 2022 (EP) 22160782.3
Mar. 8, 2022 (EP) 22160784.9

(51) Int. Cl. C08J 9/12; B01J 20/28; B01J 20/30; B01J 20/32

(52) U.S. Cl. CPC C08J 9/125; B01J 20/28004; B01J 20/28019; B01J 20/28045; B01J 20/3064; B01J 20/3274; B01J 2220/44; B01J 2220/4806; B01J 2220/4856; C08J 2389/00

(57) ABSTRACT

A porous material is prepared mixing at least one bio-based polymer and at least one polyionic biopolymer and water, in an aqueous solution of a polyvalent metal ion to prepare a gel, exposing the gel to a water-miscible solvent to obtain a gel, and drying of the gel. The porous material obtained in the method finds application as thermal insulation material, as carrier material for load and release of actives, for electrode materials in batteries, fuels cells or electrolysis, for catalysis, for capacitors, for consumer electronics, for building and construction applications, for home and commercial appliance applications, for temperature-controlled logistics applications, for vacuum insulation applications, for battery applications, for apparel applications, for food applications, for cosmetic applications, for biomedical applications, for agricultural applications, for consumer applications, for packaging applications or for pharmaceutical application or as carrier materials or adsorbents.

The present invention relates to a process for preparing a porous material, at least comprising the steps of providing a mixture (M1) comprising at least one compound (C1) selected from the group consisting of bio-based polymers and at least one polyionic biopolymer as component (C2) and water, bringing mixture (M1) into contact with an aqueous solution of a polyvalent metal ion to prepare a gel (A), exposing the gel (A) obtained to a water-miscible solvent (L) to obtain a gel (B), and drying of the gel (B). The invention further relates to the porous materials which can be obtained in this way and the use of the porous materials as thermal insulation material, as carrier material for load and release of actives, for electrode materials in batteries, fuels cells or electrolysis, for catalysis, for capacitors, for consumer electronics, for building and construction applications, for home and commercial appliance applications, for temperature-controlled logistics applications, for vacuum insulation applications, for battery applications, for apparel applications, for food applications, for cosmetic applications, for biomedical applications, for agricultural applications, for consumer applications, for packaging applications or for pharmaceutical application or as carrier materials or adsorbents.

Porous materials based on organic polymers, for example polymer foams, having pores in the size range of a few microns or significantly below and a high porosity of at least 70% are particularly suitable for various applications.

Such porous materials having a small average pore diameter can be, for example, in the form of organic aerogels or xerogels which are produced with a sol-gel process and subsequent drying. In the sol-gel process, a sol based on an organic gel precursor is first produced and the sol is then gelled by means of a crosslinking step to form a gel. To obtain a porous material, for example an aerogel, from the gel, the liquid has to be removed. This step will hereinafter be referred to as drying in the interests of simplicity.

The present invention relates to a process for the manufacturing of porous materials containing bio based polymers and polysaccharides with carboxylic acid groups, as well as to the porous material as such and their use.

In the context of the present invention, bio-based polymers are understood to be polymers which are obtained from renewable resources (algae, bacteria, microorganisms, plants, etc.). Bio-based polymers can be obtained mainly by two different ways: the direct production of polymers or the production of bio-based monomers and their further (bio) chemical polymerization. The direct production of biopolymers can be achieved by microorganisms (polyhydroxyalkanoates, PHA), by algae (alginate etc.), by superior plants (pectin etc.) or by several types of producers, e.g. cellulose is produced by superior plants but also by bacteria, chitosan is produced by crustacean but also by fungi.

In particular, the invention relates to a process for the manufacture of protein, lignin, tannin, cellulose, silica and/or alginate containing porous materials. Lignin is a non-uniform biopolymer. Depending on its origin, for example the source of wood or plant as well as the extraction method, properties, such as molar mass or degree of condensation, and also the chemical composition may vary. Typically, lignin is a disordered biopolymer with three main building units, namely coumaryl alcohol, coniferyl alcohol and sinapyl alcohol. Other suitable bio-based polymers are for example tannins. Tannins may be natural products found in tree bark and other biological sources. There are several classes of tannins which typically differ in the base or monomer unit.

In principle, porous materials based on organic polymers, preferably bio-based polymers are known from the state of the art, for example based on polysaccharides, polypeptides, polyphenolics such as cellulose, gelatine and lignin or mixtures of bio-based polymers. Preparation processes for lignin-based aerogels are also known from the state of the art.

In the scientific literature, several processes are disclosed. For example an article in the Journal of Supercritical Fluids 2015, 105, 1-8 discloses a process for the preparation of hybrid alginate-lignin aerogels using pressurized carbon dioxide for gelation. Exposure of alginate and lignin aqueous alkali solution containing calcium carbonate to CO₂ resulted in a hydrogel formation.

US20190329208A1 discloses methods for producing high-purity lignin-based carbon aerogels.

Highly porous organic aerogels based on tannin and lignin are disclosed in “New Tannin-Lignin Aerogels”, Grishechko, L. et al. Industrial Crops and Products, 41 (2013) 347-355. Hydrogels are described, which are prepared at constant solid weight fraction and constant pH, but with different tannin/lignin and (tannin+lignin)/formaldehyde weight ratios.

Generally, organic molecules such as isocyanates or aldehydes are used as crosslinker. For many applications, these compounds are disadvantageous since they often are harmful and traces may remain in the materials obtained.

Also porous materials based on alginates are known from the state of the art. A process for the manufacture of polysaccharide foams, in particular based on an alginate, is known from WO 94/00512. Also in the scientific literature, gelation processes induced by pressurized CO₂ in alginate-based systems are disclosed, for example in Partap et al. (2006, “Supercritical Carbon Dioxide in Water” Emulsion-Templated Synthesis of Porous Calcium Alginate Hydrogels. Advanced Materials 18, 501-504).

Due to their porosity and stability, aerogels or xerogels are also used as adsorbents or carrier materials. For example WO2016032733A2 describes non-dusty biopolymer aerogels for loading liquid active substances, but loading is carried out using a supercritical medium using high pressure and temperature. WO2019167013A1 describes superabsorbent polysaccharide biopolymer aerogels, but chemical crosslinking is required.

EP3741794A1 describes aerogel/hydrogel composites for loading and releasing oils or moisture such as fragrances, but dusty silica aerogel is used which needs to be hydrophobized. EP2663395B1 describes aerogel/hydrogel composites for loading and releasing drugs, but dusty silica aerogel is used which needs to be hydrophobized.

CN114958480A describes silica aerogel as carrier for fragrance, but the materials are dusty and hydrophobization is required. WO2018056652A describes silica aerogels as carriers for UV blockers to prevent skin irritation, but silica aerogel is dusty. WO2017023702A1 describes silica aerogel/polymer resins as fragrance release materials, but silica aerogels are known to be dusty and require hydrophobization. Budtova et al. (Cellulose 2019, 26, 81-121 (10.1007/s10570-018-2189-1) describe cellulose aerogels for oil or organic solvent uptake but chemical crosslinking and/or hydrophobization is required.

CN105601983B describes polysaccharide biopolymer materials based on freeze drying as aroma carriers, but chemical crosslinking is required. WO2019190379A1 describes hybrid aerogels of cellulose with chargeable polysaccharide but gelation requires energy due to heating.

The use of aerogels in pharmaceutical applications is for example disclosed in WO 96/25950 A1, WO9501165A1, WO2009062975A1 or WO02051389A2.

The materials disclosed in the state of the art are either based on silica, which is dusty and often needs hydrophobization, or they are based on chemically crosslinked biopolymers, or they require energy input for loading and heating in the preparation process.

It was an object of the invention to avoid the abovementioned disadvantages. It was one object of the present invention to provide a process for the preparation of porous materials based on bio-based polymers which avoids harmful materials. It was a further object of the present invention to provide porous materials which are suitable as thermal insulation material or as core for vacuum insulation materials or for battery applications or for electrode materials in batteries, fuels cells or electrolysis, for catalysis, for capacitors, or for cosmetic, pharmaceutical or agricultural applications. Furthermore, it was an object of the present invention to provide a process for preparing porous materials from bio-based polymers which can be used as adsorbents or carrier materials which are stable and are preferably also suitable to release a liquid which has been adsorbed.

It was a further object of the present invention to provide a porous material prepared from harmless aqueous solutions, that can be loaded with liquid or liquefied organic solvents or oils while showing little shrinkage when exposed to typical ambient conditions for storage stability.

According to the present invention, this object has been solved by a process for preparing a porous material, at least comprising the steps of:
a) providing a mixture (M1) comprising at least one compound (C1) selected from the group consisting of bio-based polymers and at least one polyionic biopolymer as component (C2) and water,
b) bringing mixture (M1) into contact with an aqueous solution of a polyvalent metal ion to prepare a gel (A)
c) exposing the gel (A) obtained in step b) to a water miscible solvent (L) to obtain a gel (B),
d) drying of the gel (B) obtained in step c).

According to a further embodiment, the present invention is also directed to a process for preparing a porous material, at least comprising the steps of:
a) providing a mixture (M1) comprising at least one compound (C1) selected from water-soluble bio-based polymers and inorganic precursors, and at least one water-soluble polysaccharide with carboxylic acid groups as component (C2) and water,
b) bringing mixture (M1) into contact with an aqueous solution of a polyvalent metal ion to prepare a gel (A)
c) exposing the gel (A) obtained in step b) to a water miscible solvent (L) to obtain a gel (B),
d) drying of the gel (B) obtained in step c).

According to the present invention, bio-based polymers and polyionic biopolymers are used to form gels. Suitable bio-based polymers, and polyionic biopolymers are in principle known from the state of the art. Preferably, polyanionic biopolymers are used as polyionic biopolymers. Suitable ionic biopolymers are for example polysaccharides, in particular polysaccharides with carboxylic acid groups.

According to the present invention, preferably bio-based polymers, and inorganic precursors, and polysaccharides with carboxylic acid groups are used to form gels. Suitable bio-based polymers, and inorganic precursors, and polysaccharides with carboxylic acid groups are in principle known from the state of the art. Suitable are in particular water-soluble bio-polymers or bio-polymers which form swollen dispersions in water. Suitable polysaccharides with carboxylic acid groups are for example alginates, pectin, modified cellulose, xanthan, hyaluronic acid or modified starch. The use of these bio-based polymers and polyionic biopolymers such as polysaccharides and their derivatives are especially attractive because of their stability, availability, renewability and low toxicity. Suitable inorganic precursors in the context of the present invention have to be soluble or at least partially soluble in the mixture (M1) and have to solidify in the gelation step.

For the purposes of the present invention, a gel is a crosslinked system based on a polymer which is present in contact with a liquid (known as solvogel or lyogel), or with water as liquid (aquagel or hydrogel). Here, the polymer phase forms a continuous three-dimensional network.

In the context of the present invention, water-soluble means that the solubility in water is sufficient to form a solution which can be used for preparing a gel. In the context of the present invention, also aqueous swollen dispersions may be used for the preparation of a gel.

According to the present invention, a gel is formed from the components of mixture (M1) and at least one polyvalent metal ion. The components (C1) and (C2) used for the process of the present invention have to be suitable to allow the formation of a gel with the polyvalent metal ion, in particular have to have suitable functional groups.

It has surprisingly been found that the claimed method allows to produce aerogels prepared from harmless aqueous solutions, that can be loaded with liquid or liquefied organic solvents or oils while showing little shrinkage when exposed to typical ambient conditions for storage stability and while showing little shrinkage when loaded to maximize liquid capacity, that are non-dusty and do not require chemical treatment such as hydrophobization or covalent crosslinking. The porous materials obtained show little shrinkage in the dry aerogel form, so the available volume remains large until the loading of the aerogel happens. Surprisingly, the process according to the present invention allows to form round hydrogel, alcogel and aerogel beads. The aerogel beads preferably show less than 50% shrinkage exposed to typical ambient conditions and preferably less than 20% shrinkage when being loaded with an active ingredient or a liquid. Preferably, the biopolymers are 100% bio-based and the aerogels do not require chemical crosslinking or hydrophobization according to the present invention.

Preferably the porous materials obtained in the process according to the present invention are suitable for loading a liquid or liquefied organic solvent or oil, and typically show less than 60% shrinkage when exposed to humidity (60% rH, 48 h, 30° C.) as dry aerogel and less than 50% shrinkage when being loaded in the shape of a round bead of approximately 3 mm average diameter.

It has surprisingly been found that the claimed method allows to produce aerogels, for example aerogels based on bio-based polymers and inorganic precursors, and at least one polysaccharide with carboxylic acid groups, with low solid content and a high surface area, preferably also a high pore volume and a small pore diameter.

Properties of the aerogels can be customized by adjusting the composition of mixture (M1), the reaction conditions at the stage of the formation of the hydrogel (gel (A)), or during solvent exchange as well as in the drying step. According to the present invention, it is possible to influence the properties of the hydrogels and/or aerogels by varying the ratio of the components, as well as by controlling the parameters of step b) and also by introducing a wide range of organic and inorganic materials in the gel matrix.

According to the present invention, at least one compound (C1) is used. Suitable bio-based polymers include for example bio-based phenolic polymers such as lignin and tannin. Suitable are for example proteins, in particular plant-based proteins, animal-based proteins, bacterial-based proteins, and fungal-based including yeast-based proteins e.g. from food industry e.g. beer brewing. For example cellulose, bacterial cellulose, modified cellulose, starch, sugars, chitosan, polyhydroxyalkanoates, whey protein isolate, potato protein isolate, starch protein isolate, gelatine, collagen, casein or derivatives thereof such as salts thereof may be used according to the present invention. Whey protein, pea protein, yeast protein and patatin are particularly suitable for preparing porous materials suitable as carrier materials.

According to a further embodiment, the present invention also relates to a process as described above, wherein compound (C1) is a protein, preferably a protein selected from the group consisting of whey protein, pea protein, yeast protein and patatin, in particular from the group consisting of whey protein.

Also inorganic precursors such as silicates, titanates, vanadates, zirconate, aluminates, borates, ferrates, chromates, molybdates, tungstates, manganates, cobaltates and metal sulfides, metal oxides or metal carbides may be used as compound (C1) according to the present intention.

According to a further embodiment, the present invention also relates to a process as described above, wherein compound (C1) is selected from the group consisting of water-soluble bio-based polyphenolic polymers and silica.

According to the present invention, the water-soluble bio-based polyphenolic polymer may also be selected from the group consisting of lignin biopolymers and tannin biopolymers, in particular selected from alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, or tannin and tannin derivatives.

According to a further embodiment, the present invention also relates to a process as described above, wherein the water-soluble bio-based polyphenolic polymer is selected from lignin biopolymers and tannin biopolymers, in particular selected from alkali lignin, Kraft lignin, hydrolytic lignin, soda lignin, aquasolv solid lignin, enzymatic lignin, lignin sulfonate, lignin carboxylate, lignin derivatives, biorefinery lignin, tannic acid, or tannin and tannin derivatives.

According to the present invention, also mixtures of two or more bio-based polymers or mixtures of one or more bio-based polymers and a metal oxide may be used as compound (C1). For example mixtures comprising one or more polymers selected from the group consisting of bio-based polymers such as lignin and tannin, cellulose, bacterial cellulose, modified cellulose, starch, sugars, chitosan, polyhydroxyalkanoates, whey protein isolate, potato protein isolate, starch protein isolate, yeast protein, gelatin, collagen, casein or derivatives thereof or mixtures comprising an inorganic precursor and one or more polymers selected from the group consisting of bio-based phenolic polymers such as lignin and tannin, cellulose, bacterial cellulose, modified cellulose, starch, sugars, chitosan, polyhydroxyalkanoates, whey protein isolate, potato protein isolate, starch protein isolate, gelatin, collagen, casein or derivatives thereof or pea protein or yeast protein can be used as component (C1).

According to the present invention, compound (C2) preferably is a polyanionic biopolymer, for example a polysaccharide. Compound (C2) may be selected from the group consisting of alginates, pectin, modified cellulose, xanthan, hyaluronic acid or modified starch. Therefore, according to a further embodiment, the present invention is also directed to a process as described above, wherein compound (C2) may be selected from the group consisting of alginates, pectin, modified cellulose, xanthan, hyaluronic acid or modified starch, preferably from the group consisting of alginates, pectin, and modified cellulose, in particular from the group consisting of modified cellulose or from the group consisting of alginates.

According to a further embodiment, the present invention also relates to a process as described above, wherein compound (C2) is a polyanionic biopolymer, preferably a polyionic biopolymer selected from the group consisting of alginates, pectin, and modified cellulose.

According to the present invention, compound (C1) may for example be selected from the group consisting of lignin and tannin. Also cellulose, bacterial cellulose, modified cellulose, starch, sugars, chitosan, polyhydroxyalkanoates, whey protein isolate, potato protein isolate, starch protein isolate, gelatine, collagen, casein or derivatives thereof, and silicates, titanates, vanadates, zirconates, aluminate, borates, ferrates, chromates, molybdates, tungstates, manganates, cobaltates and metal sulfides, metal oxides and metal carbides and compound (C2) may be alginate. According to a further embodiment, compound (C1) may for example be a mixture comprising to compounds selected from the group consisting of lignin and tannin, cellulose, bacterial cellulose, modified cellulose, starch, sugars, chitosan, polyhydroxyalkanoates, whey protein isolate, potato protein isolate, starch protein isolate, yeast protein, gelatine, collagen, casein or derivatives thereof, and silicates, titanates, vanadates, zirconates aluminates, borates, ferrates, chromates, molybdates, tungstates, manganates, cobaltates and metal sulfides, metal oxides or metal carbides and compound (C2) may be an alginate.

According to a further embodiment, compound (C1) is a protein, preferably a protein selected from the group consisting of whey protein, pea protein, yeast protein and patatin, and compound (C2) is selected from the group consisting of alginates, pectin, and modified cellulose.

According to the present invention, the amount of the compounds (C1) and (C2) used in the process may vary, for example depending on the properties of the material to be achieved. Suitable amounts for compound (C1) are for example in the range of from of 0.1% by weight to 50% by weight based on the weight of mixture (M1), preferably in the range of from 1.0 to 35% by weight based on the weight of mixture (M1), in particular in the range of from 2.0 to 20% by weight based on the weight of mixture (M1).

According to a further embodiment, the present invention therefore also relates to a process as described above, wherein mixture (M1) comprises compound (C1) in an amount of 0.1% by weight to 50% by weight based on the weight of mixture (M1).

The ratio of compound (C1) and compound (C2) may also vary, depending on the compounds used. Typically, mixture (M1) comprises compound (C1) and compound (C2) in a ratio in the range of from 55:45 to 98:2, preferably in a range of from 60:40 to 95:5.

According to a further embodiment, the present invention therefore also relates to a process as described above, wherein mixture (M1) comprises compound (C1) and compound (C2) in a ratio in the range of from 55:45 to 98:2.

In the context of the present invention, the pH value of the mixture (M1) may also vary depending on the compounds used. It has been found that advantageous results are obtained when the pH value of mixture (M1) is in the range of 7 to 14, in particular in the range of from 8 to 14 or 10 to 14, more preferable in the range of from 11 to 14. The pH value of the mixture (M1) may be adjusted to improve the solubility of the polymers used.

According to a further embodiment, the present invention also relates to a process as described above, wherein the pH value of mixture (M1) is in the range of 7 to 14.

In the process according to the present invention, a mixture (M1) is provided according to step a). The mixture can be prepared by dissolving the desired amount of compounds (C1) and (C2) in, e.g., distilled water. In the context of the present invention, it is also possible to adjust the pH value of the mixture to improve the solubility.

According to step b), mixture (M1) is brought into contact with an aqueous solution of a polyvalent metal ion to prepare a gel (A).

The aqueous solution of the polyvalent metal ion can for example be prepared using a salt of a polyvalent metal ion.

According to the present invention, polyvalent metal ions are suitable which form poorly soluble compounds with the polysaccharide with carboxylic acid groups compound (C2), and can form poorly soluble compounds with compound (C1) used, i.e. which act as cross-linking metal ions. Such polyvalent metal ions include, for example, alkaline earth metal ions and transition metal ions which form poorly soluble compounds with the polysaccharide with carboxylic acid groups. Alkaline earth metal ions, such as magnesium or calcium are preferred. Calcium is particularly preferred. Also trivalent metal ions such as aluminum or iron are particularly suitable. Calcium salts are particularly preferred according to the invention for they are physiologically and, particularly, cosmetically acceptable and have a strong cross-linking and/or gelation effect compared to alginate. In addition, e.g. beryllium, barium, strontium, zinc, cobalt, nickel, copper, manganese, iron, chromium, vanadium, titanium, zirconium, cadmium, molybdenum, tungsten, ruthenium, rhodium, iridium, palladium, platinum, aluminum can also be used. According to the present invention, also mixtures of two or more polyvalent ions may be used, for example mixtures comprising divalent and trivalent ions, such as mixtures comprising calcium and aluminum or mixtures comprising calcium and ion.

The polyvalent metal ions preferably are added in the form of their salts. In principle, the corresponding anions can be selected arbitrarily. Preferably, chlorides, acetates, nitrates—can be utilized, preferably calcium chloride or salts of trivalent metals such as iron (III) chloride, aluminum chloride or iron (III) nitrate or mixtures thereof.

The amount of the salt of the polyvalent metal ion is selected, so that the concentration of the salt in the resulting solution preferably is between about 1 to 20% by weight, preferably in the range of from 1 to 10% by weight, in particular in the range of from 1 to 5% by weight, more preferable in the range of from 1 to 3% by weight.

According to a further embodiment, the present invention also relates to a process as described above, wherein the polyvalent metal ion is a divalent metal ion, in particular a divalent metal ion selected from earth alkali metal ions.

According to a further embodiment, the present invention also relates to a process as described above, wherein the polyvalent metal ion is a trivalent metal ion selected from the group consisting of aluminum ions and iron (III) ions.

According to the present invention, also mixtures of polyvalent metal ions can be used.

The mixture (M1) provided in step (a) can also comprise further salts, in particular such salts that do not form gels, and customary auxiliaries known to those skilled in the art as further constituents.

Furthermore, the mixture (M1) can comprise cosmetic or medical active substances or pharmaceutical agents or agents for agriculture or actives for food.

Typically, the cosmetic or medical active substances or pharmaceutical agents or agents for agriculture or actives for food at least partially remain in the gel or the porous material under the conditions of the process according to the present invention.

Suitable are for example substances which are water soluble or can be dispersed in water.

Suitable substances may for example be selected from hyaluronic acid, collagen, keratin, silk fibroin, tannin, lignin (both as anti-oxidant or sun protection factor), enzymes, polyvinylpyrrolidone (PVP), and povidone. Furthermore, suitable additives may be whitening actives; free radical scavengers, UV absorbers, barrier lipids, desquamatory actives, retinoids, tanning actives, skin brighteners, skin activators, chelators, flavonoids, moisturizing actives, exfoliating agents, anti-acne actives, anti-caking agents, anti-cellulite agents, anti-foaming agents, anti-fungal actives, anti-inflammatory actives, anti-microbial actives, anti-oxidants, antiperspirant/deodorant actives, anti-skin atrophy actives, anti-viral agents, anti-wrinkle actives, artificial tanning agents and accelerators, astringents, barrier repair agents, binders, buffering agents, bulking agents, chelating agents, colorants, dyes, enzymes, essential oils, film formers, flavors, humectants, hydrocolloids, light diffusers, nail enamels, opacifying agents, optical brighteners, optical modifiers, particulates, perfumes, pH adjusters, preservatives, sequestering agents, skin conditioners/moisturizers, skin feel modifiers, skin protectants, skin sensates, skin treating agents, skin exfoliating agents, skin lightening agents, skin soothing and/or healing agents, skin thickeners, sunscreen actives, topical anesthetics, vitamin compounds, and combinations thereof.

Suitable substances may be triglycerides, vegetable oils, vegetable oil derivatives, acetoglyceride esters, alkyl esters, allcenyl esters, lanolin and its derivatives, wax esters, beeswax derivatives, sterols and phospholipids, and combinations thereof; hydrocarbon oils and waxes or silicone oils, and combinations thereof.

Suitable substances may also be pharmaceutical compositions containing one or more pharmaceutical agents preferably for oral administration. The one or more pharmaceutical agents are selected from therapeutic agents and diagnostic agents. Examples of suitable therapeutic agents include, but are not limited to, drugs acting at synaptic sites and neuroeffector junctional sites; general and local analgetics; hypnotics and sedatives; drugs for the treatment of psychiatric disorders such as depression and schizophrenia; anti-epileptics and anticonvulsants; drugs for the treatment of Parkinson's and Huntington's disease, aging and Alzheimer's disease; excitatory amino acid antagonists, neurotrophic factors and neuroregenerative agents; trophic factors; drugs aimed at the treatment of CNS trauma or stroke; drugs for the treatment of addiction and drug abuse; anti-obesity drugs; antacoids and anti-inflammatory drugs; chemotherapeutic agents for parasitic infections and diseases caused by microbes; immunosuppressive agents and anti-cancer drugs; hormones and hormone antagonists; heavy metals and heavy metal antagonists; antagonists for non-metallic toxic agents; cytostatic agents for the treatment of cancer; diagnostic substances for use in nuclear medicine; immunoactive and immunoreactive agents; transmitters and their respective receptor agonists and receptor antagonists, their respective precursors and metabolites; transporter inhibitors; antibiotics; antispasmodics; antihistamines; antinauseants; relaxants; stimulants; sense and antisense oligonucleotides; cerebral dilators; psychotropics; antimanics; vascular dilators and constrictors; anti-hypertensives; drugs for migraine treatment; hypnotics, hyperglycemic and hypoglycemic agents; anti-asthmatics; antiviral agents, preferably anti HIV agents; genetic material suitable for the DNA, si-RNA or anti-sense treatment of diseases; and mixtures thereof. Examples of suitable diagnostic agents include, but are not limited to, diagnostics useful in the diagnosis in nuclear medicine and in radiation therapy

Suitable substances may also be fragrances or fragrance compositions which typically at least partially remain in the gel or the porous material under the conditions of the process according to the present invention. The fragrance may be any fragrant substance or mixture of substances, including natural and synthetic substances that provide a favorable aroma. In addition, the fragrance may contain auxiliary materials such as fixatives, extenders, stabilizers, and solvents. Examples of suitable fragrances include, but are not limited to, silicon oils, essential oils, absolutes, resinoids, resins, and synthetic perfume components such as hydrocarbons, alcohols, aldehydes, ketones, ethers, acids, esters, acetals, ketals, nitrites, including saturated and unsaturated compounds, aliphatic, carbocyclic and heterocyclic compounds. It should be recognized that certain fragrances may include additional components that function as, for example, carriers, diluents, stabilizers, etc. Exemplary additional components include glycols and vegetable oils. The reference to the fragrance component includes the fragrance as well as any additional component combined with the fragrance to provide a beneficial property such as stability, viscosity, etc. Examples of suitable fragrances, or perfumes, are for example provided in U.S. Pat. No. 5,234,610.

According to a further embodiment, the present invention also relates to a process as described above, wherein a compound (C) is added to mixture (M1) in step a) which is suitable to form a gel. Compound (C) may be soluble or partially soluble in the mixture (M1). In the context of the present invention, it is also possible that compound (C) is insoluble in the mixture (M1).

According to a further embodiment, the present invention also relates to a process as described above, wherein a water insoluble solid (S) is brought into contact with mixture (M1).

Solid (S) may for example be a porous material or foam, a carrier or a fibrous material. According to the present invention, it is also possible that mixture (M1) is present in the pores of a solid (S).

According to a further embodiment, the present invention also relates to a process as described above, wherein a compound (C) is added to mixture (M1) selected from pigments, opacifiers, flame retardants, metals, metal particles, metal nanoparticles, metal fibers, metal meshes, metal oxides, metal oxide particles, metal oxide nanoparticles, metal oxide fibers, metal salts, metals for catalysis, catalytic materials, metal carbide or metal sulfide particles or nanoparticles, silicon-based materials, silicon particles, silicon nanoparticles, semiconductor-based materials, semiconductor particles, semiconductor nanoparticles, semiconductor fibers, semiconductor meshes, carbon materials, carbon black, graphite nanoparticles, graphite fibers, graphite sheets, graphite meshes, graphene nanoparticles, graphene fibers, graphene sheets, graphene meshes, metal-organic frameworks, sulfur, inorganic and/or organic fillers, nucleating agents, stabilizers, heat control member, surface-active substances, fibers and foam reinforcement.

According to step b) of the present invention, mixture (M1) is brought into contact with an aqueous solution of a polyvalent metal ion to prepare a gel (A). Suitable mixing steps are in principle known to the person skilled in the art. It is for example possible to add mixture (M1) dropwise to the aqueous solution of the polyvalent metal ion. It is also possible that mixture (M1) is provided in the pores of a carrier material or in admixture with fibers before bringing it into contact with the aqueous solution of a polyvalent metal ion to prepare a gel (A). Also, mixture (M1) can be brought into contact with the polyvalent metal ion in an emulsion or in a spray process.

Gelling is known per se to a person skilled in the art and is described, for example, in WO 2009/027310 on page 21, line 19 to page 23, line 13.

Preferably, the conditions are adjusted and the hydrogel, alcogel and/or aerogel exhibit a round shape. Preferably, according to step b), a round bead with an average diameter in the range of from 0.5 to 3 mm is obtained. Preferably, no crosslinking or hydrophobization via covalent chemical reaction occurs.

Preferably, temperature and pressure in step b) are adjusted to conditions under which a gel is formed. A suitable temperature might be in the range of from 5 to 40° C., preferable in the range of from 15 to 35° C. According to a further embodiment, the present invention also relates to a process as described above, wherein step b) is carried out at a temperature in the range of from 5 to 40° C.

The rate of formation of the insoluble gel can be controlled very exactly and easily by choosing suitable conditions for step b).

Gel (A) obtained in step b) is a gel comprising water, i.e. a hydrogel. According to the present invention gel (A) obtained in step b) is exposed to a water-miscible solvent (L) to obtain a gel (B) in step c) of the process of the present invention.

However, it is also possible to use the hydrogel (A) obtained as an intermediate of the process as disclosed above as such. Many applications for hydrogels are known. The hydrogel (A) is particularly homogenous, and particles can be prepared according to the present invention which can be subjected to further process steps.

According to the present invention, a water-miscible solvent (L) is used in step c). In the context of the present invention, water-miscible means that the solvent is at least partially miscible with water in order to allow an exchange of solvent in the gel.

Solvent exchange is carried out either by soaking the gel directly in the new solvent (one-step) or by following a sequential soaking (multi-step) in different water-to-new solvent mixtures with increasing content in the new solvent after a certain time (exchange frequency) in the previous soaking step (Robitzer et al., 2008, Langmuir, 24 (21), 12547-12552). The solvent chosen for water replacement must satisfy the requirements of not dissolving the gel structure, being completely soluble with the solvent which precedes them (water) and preferably also accepted for manufacturing of pharmaceuticals. Furthermore, in case the process encompasses a step of supercritical drying, solvent (L) preferably is at least partially miscible with the supercritical medium.

The solvent (L) can in principle be any suitable compound or mixture of a plurality of compounds, which meets the above requirements with the solvent (L) being liquid under the temperature and pressure conditions of step c).

Possible solvents (L) are, for example, alcohols, ketones, aldehydes, alkyl alkanoates, organic carbonates, amides such as formamide and N-methylpyrollidone, sulfoxides such as dimethyl sulfoxide, aliphatic and cycloaliphatic halogenated or non-halogenated hydrocarbons, halogenated or non-halogenated aromatic compounds and fluorine-containing ethers. Mixtures of two or more of the abovementioned compounds are likewise possible.

In many cases, particularly suitable solvents (L) are obtained by using two or more completely miscible compounds selected from the above mentioned solvents.

Suitable solvents are in particular alcohols and ketones, for example C1 to C6 alcohols and C1 to C6 ketones and mixtures thereof.

According to a further embodiment, the present invention also relates to a process as described above, wherein the solvent (L) used in step c) is selected from the group consisting of C1 to C6 alcohols and C1 to C6 ketones and mixtures thereof.

Particularly suitable are alcohols such as methanol, ethanol and isopropanol and ketones such as acetone, and methyl ethyl ketone.

The solvent exchange according to step b) might be carried out in one step, 2 steps, 3 steps or in multiple steps with varying concentration of the solvent. According to a preferred embodiment, gels (A) are successively immersed in ethanol/water mixtures with concentrations of for example 30, 60, 90 and 100 wt % for 5 min to 12 h in each depending on the particle size and porosity.

In step c), gel (B) is obtained. According to step d) of the process of the present invention, gel (B) obtained in step c) is dried.

Drying in step (d) takes place in a known manner. Drying under supercritical conditions is preferred, preferably after replacement of the solvent by CO₂ or other solvents suitable for the purposes of supercritical drying. Such drying is known per se to a person skilled in the art. Supercritical conditions characterize a temperature and a pressure at which CO₂ or any solvent used for removal of the gelation solvent is present in the supercritical state. In this way, shrinkage of the gel body on removal of the solvent can be reduced.

In the context of the present invention it is also possible to dry the gels obtained by conversion of the liquid comprised in the gel into the gaseous state at a temperature and a pressure below the critical temperature and the critical pressure of the liquid comprised in the gel.

According to one embodiment, the drying of the gel obtained is preferably carried out by converting the solvent (L) into the gaseous state at a temperature and a pressure below the critical temperature and the critical pressure of the solvent (L). Accordingly, drying is preferably carried out by removing the solvent (L) which was present in the reaction without prior replacement by a further solvent.

Such methods are likewise known to those skilled in the art and are described in WO 2009/027310 on page 26, line 22 to page 28, line 36.

According to a further embodiment, the present invention also relates to a process as described above, wherein the drying according to step d) is carried out by converting the liquid comprised in the gel into the gaseous state at a temperature and a pressure below the critical temperature and the critical pressure of the liquid comprised in the gel.

According to a further embodiment, the present invention also relates to a process as described above, wherein the drying according to step d) is carried out under supercritical conditions.

The process might also comprise one or more further modification steps such as a shaping step that may include fibers and/or adhesives and/or thermoplastic materials, a compression step, a lamination step, a hydrophobization step, or a carbonization step. It is for example possible to combine one or more of these steps, for example a post-drying and a hydrophobization step.

According to a further embodiment, the present invention also relates to a process as described above, wherein in the process comprises one or more further modification steps of the dried gel.

According to a further embodiment, the present invention also relates to a process as described above, wherein the modification step is selected from the group consisting of a shaping step, a compression step, a lamination step, a post-drying, a hydrophobization step, and a carbonization step.

The present invention also relates to a porous material, which is obtained or obtainable by the process as described above. The porous materials of the present invention are preferably aerogels or xerogels or cryogels.

For the purposes of the present invention, a xerogel is a porous material which has been produced by a sol-gel process in which the liquid phase has been removed from the gel by drying below the critical temperature and below the critical pressure of the liquid phase (“subcritical conditions”). An aerogel is a porous material which has been produced by a sol-gel process in which the liquid phase has been removed from the gel under supercritical conditions. A cryogel is a porous material which is produced by freezing the solvent in the gel and removal of the solid solvent through a sublimation process at ambient conditions.

The process as disclosed above results in porous materials with improved properties. Aerogels produced according to the process of the present invention preferably have a low density, and preferably high specific surface area, for example in the range of from 200 to 800 m²/g. Furthermore, a pore volume in the range of from 2.1 to 9.5 cm³/g for pore sizes<100 nm can preferably be obtained.

Preferably, the porous material obtained shows less than 60% shrinkage when exposed to humidity (60% rH, 48 h, 30° C.) as dry aerogel and less than 50% shrinkage when being loaded in the shape of a round bead with an average diameter of 3 mm.

Furthermore, the present invention therefore is directed to a porous material which is obtained or obtainable by the process for preparing a porous material as disclosed above. In particular, the present invention is directed to a porous material which is obtained or obtainable by the process for preparing a porous material as disclosed above, wherein the drying according to step d) is carried out under supercritical conditions.

The porous material according to the invention preferably has a density in the range of 0.005 to 1 g/cm³, preferably from 0.01 to 0.5 g/cm³ (determined according to DIN 53420).

The average pore diameter is determined by scanning electron microscopy and subsequent image analysis using a statistically significant number of pores. Corresponding methods are known to those skilled in the art. For characterization of the porous structure of aerogels a Nova 3000 Surface Area Analyzer from Quantachrome Instruments was used. It uses adsorption and desorption of nitrogen at a constant temperature of 77 K.

The volume average pore diameter of the porous material is preferably not more than 1 micron. The volume average pore diameter of the porous material is particularly preferably not more than 750 nm, very particularly preferably not more than 500 nm and in particular not more than 250 nm. The volume average pore diameter of the porous material may for example be in a range of from 1 to 1000 nm, preferably in the range of from 2 to 500 nm, in particular in the range of from 3 to 250 nm, more preferable in the range of from 5 to 100 nm or particularly preferred in the range of from 10 to 50 nm.

The porous material which can be obtained according to the invention preferably has a porosity of at least 70% by volume, in particular from 70 to 99% by volume, particularly preferably at least 80% by volume, very particularly preferably at least 85% by volume, in particular from 85 to 95% by volume. The porosity in % by volume means that the specified proportion of the total volume of the porous material comprises pores. Although a very high porosity is usually desirable from the point of view of a minimal thermal conductivity, an upper limit is imposed on the porosity by the mechanical properties and the processability of the porous material.

According to a further embodiment, the present invention also relates to a porous material as disclosed above, wherein the specific surface area of the porous material is in the range of from 200 to 800 m²/g, determined using the BET theory according to DIN 66134:1998-0.

It has been surprisingly found that according to the present invention, it is possible to obtain material which have a very low content of volatile organic compounds even if the starting materials used may contain higher amounts of volatile organic compounds. For example lignins often contain volatile organic compounds due to their preparation process such as for example guaiacol.

According to a further embodiment, the present invention therefore also relates to a porous material as disclosed above, wherein the content of volatile organic compounds (VOC) in the porous material is less than 50% of the content of volatile organic compounds (VOC) in the starting materials used in the process.

According to a further embodiment, the present invention also relates to a porous material as disclosed above, wherein the porous material is bead shaped and preferably has an average diameter in the range of 0.5 mm to 3 mm.

The porous materials according to the present invention can be loaded with liquid or liquefied organic solvents or oils while showing little shrinkage when exposed to typical ambient conditions for storage stability while showing little shrinkage when loaded to maximize liquid capacity. The porous materials according to the present invention show little shrinkage in the dry aerogel form, so the available volume remains large until the loading of the aerogel happens. The porous materials according to the present invention have excellent adsorption properties and excellent mechanical stability such that it is able to carry the adsorbed matter and allow for steady release under ambient conditions.

According to the present invention, for example cosmetic or medical active substances or pharmaceutical agents or agents for agriculture or actives for food or fragrances or fragrance compositions may be introduced during the preparation process as set out above which are then at least partially present in the porous material and may also be released under suitable conditions.

According to the present invention it is also possible to bring the porous materials into contact with a suitable liquid composition comprising cosmetic or medical active substances or pharmaceutical agents or agents for agriculture or actives for food or fragrances or fragrance compositions which are then at least partially adsorbed. Preferably, the process comprises mixing the porous material with the liquid composition and allowing a sufficient time for an effective amount of said composition to be adsorbed onto and/or absorbed by the porous material. The liquid composition may be a solution, preferably a highly concentrated solution. Suitable are for example solutions or dispersions comprising cosmetic or medical active substances or pharmaceutical agents or agents for agriculture or actives for food or fragrances or fragrance compositions and a suitable solvent. In the context of the present invention, it is also possible to use liquid active substances as such without the addition of a solvent. The porous material containing the adsorbed substances may then be separated from any remaining solution or dispersion. It is also possible to release the adsorbed substances under suitable conditions according to the present invention.

The loaded quantity of the liquid composition depends on the density of the liquid, the density of the dry porous material and the shrinkage of the dry porous material upon loading with the liquid composition. The loaded quantity of the liquid composition may be as high as 60 g/g, preferably as high as 50 g/g, more preferably as high as 45 g/g and as low as 5 g/g, preferably as low as 7 g/g.

According to a further aspect, the present invention relates to the use of porous materials as disclosed above or a porous material obtained or obtainable by the process as disclosed above as carrier materials or adsorbents.

The porous materials which can be obtained according to the invention preferably have a high porosity and a low density. In addition, the porous materials preferably have a small average pore size. The combination of the abovementioned properties allows the materials to be used as insulation material in the field of thermal insulation, in particular for applications in the ventilated state as building materials or in refrigerators, temperature-controlled logistics, apparels, or batteries.

The present invention is also directed to the use of porous materials as disclosed above or a porous material obtained or obtainable according to a process as disclosed above as thermal insulation material or for vacuum insulation panels. The thermal insulation material is for example insulation material which is used for insulation in the interior or the exterior of a building. The porous material according to the present invention can advantageously be used in thermal insulation systems such as for example composite materials.

Furthermore, the present invention relates to the use of the porous materials according to the invention for battery applications, for electrode materials in batteries, fuels cells or electrolysis, for catalysis, for capacitors, for cosmetic applications, for biomedical applications, for pharmaceutical applications, for agricultural applications and also for the manufacture of a medical product. Such cosmetic applications include for example products for facial treatment or as skin scrubbing or cleansing or protective products such as products for UV protection or products including antioxidants.

According to a further aspect, the present invention relates to the use of porous materials as disclosed above or a porous material obtained or obtainable by the process as disclosed above as thermal insulation material, for cosmetic applications, for biomedical applications or for pharmaceutical applications. According to a further preferred aspect, the present invention relates to the use of porous materials as disclosed above or a porous material obtained or obtainable by the process as disclosed above as thermal insulation material, as carrier material for load and release of actives, for electrode materials in batteries, fuels cells or electrolysis, for catalysis, for capacitors, for consumer electronics, for building and construction applications, for home appliance applications, for temperature-controlled logistics applications, for vacuum insulation applications, for battery applications, for apparel applications, for food applications, for cosmetic applications, for biomedical applications, for agricultural applications, for consumer applications, for packaging applications or for pharmaceutical application.

Preferred embodiments may be found in the claims and the description. Combinations of preferred embodiments do not go outside the scope of the present invention. Preferred embodiments of the components used are described below.

The present invention includes the following embodiments, wherein these include the specific combinations of embodiments as indicated by the respective interdependencies defined therein.
1. Process for preparing a porous material, at least comprising the steps of:
   a) providing a mixture (M1) comprising at least one compound (C1) selected from the group consisting of water-soluble bio-based polymers and inorganic precursors and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
2. The process according to embodiment 1, wherein compound (C1) is selected from the group consisting of water-soluble bio-based polyphenolic polymers and silica.
3. The process according to any of embodiments 1 or 2, wherein mixture (M1) comprises compound (C1) in an amount of 0.1% by weight to 50% by weight based on the weight of mixture (M1).
4. The process according to any of embodiments 1 to 3, wherein mixture (M1) comprises compound (C1) and compound (C2) in a ratio in the range of from 55:45 to 98:2.
5. The process according to any of embodiments 1 to 4, wherein the pH value of mixture (M1) is in the range of 7 to 14, in particular 8 to 14.
6. The process according to any of embodiments 1 to 5, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
7. The process according to any of embodiments 1 to 6, wherein the process comprises one or more further modification steps of the dried gel, in particular wherein the modification step is selected from the group consisting of a shaping step, a compression step, a lamination step, a post-drying step, a hydrophobization step, and a carbonization step.
8. The process according to any of embodiments 1 to 7, wherein the solvent (L) used in step c) is selected from the group consisting of C1 to C6 alcohols and C1 to C6 ketones and mixtures thereof.
9. The process according to any of embodiments 1 to 8, wherein a water insoluble solid (S) is brought into contact with mixture (M1).
10. The process according to any of embodiments 1 to 9, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
11. The process according to any of embodiments 1 to 10, wherein the drying according to step d) is carried out by converting the liquid comprised in the gel into the gaseous state at a temperature and a pressure below the critical temperature and the critical pressure of the liquid comprised in the gel.
12. The process according to any of embodiments 1 to 10, wherein the drying according to step d) is carried out under supercritical conditions.
13. A porous material, which is obtained or obtainable by the process according to any of embodiments 1 to 12.
14. The porous material according to embodiment 13, wherein the specific surface area of the porous material is in the range of from 200 to 800 m²/g, determined using the BET theory according to DIN 66134:1998-0 and the pore volume is in the range of from 2.1 to 9.5 cm³/g for pore sizes<150 nm.
15. The porous material according to embodiment 13 or 14, wherein the content of volatile organic compounds (VOC) in the porous material is less than 50% of the content of volatile organic compounds (VOC) in the starting materials used in the process.
16. The use of porous materials according to any of embodiments 13 to 15 or a porous material obtained or obtainable by the process according to any of embodiments 1 to 12 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
17. Process for preparing a porous material, at least comprising the steps of:
   a) providing a mixture (M1) comprising at least one compound (C1) selected from the group consisting of water-soluble bio-based polyphenolic polymers and silica and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
18. The process according to embodiment 17, wherein compound (C1) is selected from the group consisting of lignin biopolymers and silica.
19. The process according to any of embodiments 17 or 18, wherein mixture (M1) comprises compound (C1) in an amount of 0.1% by weight to 50% by weight based on the weight of mixture (M1).
20. The process according to any of embodiments 17 to 19, wherein mixture (M1) comprises compound (C1) and compound (C2) in a ratio in the range of from 55:45 to 98:2.
21. The process according to any of embodiments 17 to 20, wherein the pH value of mixture (M1) is in the range of 7 to 14, in particular 8 to 14.
22. The process according to any of embodiments 17 to 21, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
23. The process according to any of embodiments 17 to 22, wherein the process comprises one or more further modification steps of the dried gel, in particular wherein the modification step is selected from the group consisting of a shaping step, a compression step, a lamination step, a post-drying step, a hydrophobization step, and a carbonization step.
24. The process according to any of embodiments 17 to 23, wherein the solvent (L) used in step c) is selected from the group consisting of C1 to C6 alcohols and C1 to C6 ketones and mixtures thereof.
25. The process according to any of embodiments 17 to 24, wherein a water insoluble solid (S) is brought into contact with mixture (M1).
26. The process according to any of embodiments 17 to 25, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
27. The process according to any of embodiments 17 to 26, wherein the drying according to step d) is carried out by converting the liquid comprised in the gel into the gaseous state at a temperature and a pressure below the critical temperature and the critical pressure of the liquid comprised in the gel.
28. The process according to any of embodiments 17 to 26, wherein the drying according to step d) is carried out under supercritical conditions.
29. A porous material, which is obtained or obtainable by the process according to any of embodiments 17 to 28.
30. The porous material according to embodiment 29, wherein the specific surface area of the porous material is in the range of from 200 to 800 m²/g, determined using the BET theory according to DIN 66134:1998-0 and the pore volume is in the range of from 2.1 to 9.5 cm³/g for pore sizes<150 nm.
31. The porous material according to embodiment 29 or 30, wherein the content of volatile organic compounds (VOC) in the porous material is less than 50% of the content of volatile organic compounds (VOC) in the starting materials used in the process.
32. The use of porous materials according to any of embodiments 29 to 31 or a porous material obtained or obtainable by the process according to any of embodiments 17 to 28 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
33. Process for preparing a porous material, at least comprising the steps of:
   a) providing a mixture (M1) comprising at least one compound (C1) selected from the group consisting of water-soluble lignin biopolymers and silica and at least one water-soluble polysaccharide with carboxylic acid groups as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c),
wherein compound (C2) is selected from the group consisting of alginates, pectin, modified cellulose, xanthan, hyaluronic acid or modified starch.
34. The process according to embodiment 33, wherein compound (C2) is selected from the group consisting of alginates.
35. The process according to any of embodiments 33 or 34, wherein mixture (M1) comprises compound (C1) in an amount of 0.1% by weight to 50% by weight based on the weight of mixture (M1).
36. The process according to any of embodiments 33 to 35, wherein mixture (M1) comprises compound (C1) and compound (C2) in a ratio in the range of from 55:45 to 98:2.
37. The process according to any of embodiments 33 to 36, wherein the pH value of mixture (M1) is in the range of 7 to 14 or 8 to 14.
38. The process according to any of embodiments 33 to 37, wherein the polyvalent metal ion is a divalent metal ion, in particular a divalent metal ion selected from the group consisting of earth alkali metal ions or wherein the polyvalent metal ion is a trivalent metal ion selected from the group consisting of aluminum ions and iron (III) ions.
39. The process according to any of embodiments 33 to 38, wherein the process comprises one or more further modification steps of the dried gel, in particular wherein the modification step is selected from the group consisting of a shaping step, a compression step, a lamination step, a post-drying step, a hydrophobization step, and a carbonization step.
40. The process according to any of embodiments 33 to 39, wherein the solvent (L) used in step c) is selected from the group consisting of C1 to C6 alcohols and C1 to C6 ketones and mixtures thereof.
41. The process according to any of embodiments 33 to 40, wherein a water insoluble solid (S) is brought into contact with mixture (M1).
42. The process according to any of embodiments 33 to 41, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
43. The process according to any of embodiments 33 to 42, wherein the drying according to step d) is carried out by converting the liquid comprised in the gel into the gaseous state at a temperature and a pressure below the critical temperature and the critical pressure of the liquid comprised in the gel.
44. The process according to any of embodiments 33 to 42, wherein the drying according to step d) is carried out under supercritical conditions.
45. A porous material, which is obtained or obtainable by the process according to any of embodiments 33 to 44.
46. The porous material according to embodiment 45, wherein the specific surface area of the porous material is in the range of from 200 to 800 m²/g, determined using the BET theory according to DIN 66134:1998-0 and the pore volume is in the range of from 2.1 to 9.5 cm³/g for pore sizes<150 nm.
47. The porous material according to embodiment 45 or 46, wherein the content of volatile organic compounds (VOC) in the porous material is less than 50% of the content of volatile organic compounds (VOC) in the starting materials used in the process.
48. The use of porous materials according to any of embodiments 45 to 47 or a porous material obtained or obtainable by the process according to any of embodiments 33 to 44 as thermal insulation material, as carrier material for load and release of actives, for battery applications, for electrode materials in batteries, fuels cells or electrolysis, for catalysis, for capacitors, for consumer electronics, for building and construction applications, for home appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical application.
49. Process for preparing a porous material, at least comprising the steps of:
   a) providing a mixture (M1) comprising at least one compound (C1) selected from the group consisting of lignin biopolymers and silica and at least one water-soluble polysaccharide with carboxylic acid groups as component (C2) and water,
   b) bringing mixture (M1) into contact with an aqueous solution of a divalent or trivalent metal ion to prepare a gel (A)
   c) exposing the gel (A) obtained in step b) to a water miscible solvent (L) to obtain a gel (B),
   d) drying of the gel (B) obtained in step c),
wherein compound (C2) is selected from the group consisting of alginates, pectin, modified cellulose, xanthan, hyaluronic acid or modified starch.
50. Process for preparing a porous material, at least comprising the steps of:
   a) providing a mixture (M1) comprising water, at least one compound (C1) selected from the group consisting of lignin biopolymers and silica and at least one component (C2) selected from the group consisting of alginates,
   b) bringing mixture (M1) into contact with an aqueous solution of a divalent or trivalent metal ion to prepare a gel (A)
   c) exposing the gel (A) obtained in step b) to a water miscible solvent (L) to obtain a gel (B),
   d) drying of the gel (B) obtained in step c).
51. Process for preparing a porous material, at least comprising the steps of:
   a) providing a mixture (M1) comprising at least one compound (C1) selected from the group consisting of bio-based polymers and at least one polyionic biopolymer as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
52. The process according to embodiment 51, wherein compound (C1) is a protein, preferably a protein selected from the group consisting of whey protein, pea protein, yeast protein and patatin, in particular from the group consisting of whey protein.
53. Process for preparing a porous material, at least comprising the steps of:
   a) providing a mixture (M1) comprising at least one compound (C1) selected from the group consisting of bio-based polymers and at least one polyionic biopolymer as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
wherein compound (C1) is a protein, preferably a protein selected from the group consisting of whey protein, pea protein, yeast protein and patatin, in particular from the group consisting of whey protein.
54. The process according to any one of embodiments 51 to 53, wherein compound (C2) is a polyanionic biopolymer, preferably a polyionic biopolymer selected from the group consisting of alginates, pectin, and modified cellulose.
55. Process for preparing a porous material, at least comprising the steps of:
   a) providing a mixture (M1) comprising at least one compound (C1) selected from the group consisting of bio-based polymers and at least one polyionic biopolymer as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c),
wherein compound (C1) is a protein, preferably a protein selected from the group consisting of whey protein, pea protein, yeast protein and patatin, in particular from the group consisting of whey protein, and wherein compound (C2) is a polyanionic biopolymer, preferably a polyionic biopolymer selected from the group consisting of alginates, pectin, and modified cellulose.
56. The process according to any of embodiments 51 to 55, wherein mixture (M1) comprises compound (C1) in an amount of 0.1% by weight to 50% by weight based on the weight of mixture (M1).
57. The process according to any of embodiments 51 to 56, wherein mixture (M1) comprises compound (C1) and compound (C2) in a ratio in the range of from 55:45 to 98:2.
58. The process according to any of embodiments 51 to 57, wherein the process comprises one or more further modification steps of the dried gel, in particular wherein the modification step is selected from the group consisting of a shaping step, a compression step, a lamination step, a post-drying step, a hydrophobization step, and a carbonization step.
59. The process according to any of embodiments 51 to 58, wherein the solvent (L) used in step c) is selected from the group consisting of C1 to C6 alcohols and C1 to C6 ketones and mixtures thereof.
60. The process according to any of embodiments 51 to 59, wherein a water insoluble solid (S) is brought into contact with mixture (M1).
61. The process according to any of embodiments 51 to 60, wherein a compound (C) is added to mixture (M1) selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.
62. A porous material, which is obtained or obtainable by the process according to any of embodiments 51 to 61.
63. A porous material, which is obtained or obtainable by a process, at least comprising the steps of:
   a) providing a mixture (M1) comprising at least one compound (C1) selected from the group consisting of bio-based polymers and at least one polyionic biopolymer as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c).
64. A porous material, which is obtained or obtainable by a process, at least comprising the steps of:
   a) providing a mixture (M1) comprising at least one compound (C1) selected from the group consisting of bio-based polymers and at least one polyionic biopolymer as component (C2) and water,
   b) bringing mixture (M1) into contact with an aqueous solution of a polyvalent metal ion to prepare a gel (A)
   c) exposing the gel (A) obtained in step b) to a water miscible solvent (L) to obtain a gel (B),
   d) drying of the gel (B) obtained in step c),
wherein compound (C1) is a protein, preferably a protein selected from the group consisting of whey protein, pea protein, yeast protein and patatin, in particular from the group consisting of whey protein, and wherein compound (C2) is a polyanionic biopolymer, preferably a polyionic biopolymer selected from the group consisting of alginates, pectin, and modified cellulose.
65. The porous material according to any one of embodiments 62 to 64, wherein the specific surface area of the porous material is in the range of from 200 to 800 m²/g, determined using the BET theory according to DIN 66134:1998-0 and the pore volume is in the range of from 2.1 to 9.5 cm³/g for pore sizes<150 nm.
66. The porous material according to any one of embodiments 60 to 65, wherein the content of volatile organic compounds (VOC) in the porous material is less than 50% of the content of volatile organic compounds (VOC) in the starting materials used in the process.
67. The porous material according to any one of embodiments 62 to 66, wherein the porous material is bead shaped and preferably has an average diameter in the range of 0.5 mm to 3 mm.
68. The use of porous materials according to any of embodiments 62 to 67 or a porous material obtained or obtainable by the process according to any of embodiments 51 to 61 as carrier materials or adsorbents.
69. The use of porous materials according to any of embodiments 62 to 67 or a porous material obtained or obtainable by the process according to any of embodiments 51 to 61 as thermal insulation material, as carrier material for load and release of actives, for battery applications, for electrode materials in batteries, fuels cells or electrolysis, for catalysis, for capacitors, for consumer electronics, for building and construction applications, for home and commercial appliance applications, for temperature-controlled logistics applications, for vacuum insulation applications, for apparel applications, for food applications, for cosmetic applications, for biomedical applications, for agricultural applications, for consumer applications, for packaging applications or for pharmaceutical applications.

Examples will be used below to illustrate the invention.

### EXAMPLES

### 1. Preparation Examples

Materials: Kraft lignin (UPM), sodium hydroxide (NaOH, Sigma Aldrich), calcium chloride (CaCl₂), Sigma Aldrich), pure ethanol (Sigma Aldrich), sodium alginate (Hydagen, BASF), hexamethyldisilazane (HMDZ, Sigma Aldrich), Ludox SM30 (Sigma Aldrich), whey protein (Agropure Ingredients), xanthan (Sigma Aldrich), microcrystalline cellulose (MCC, Sigma Aldrich), sodium caseinate (Sigma Aldrich), tannic acid (Sigma Aldrich), potato starch (Sigma Aldrich), gelatin (Sigma Aldrich), pea protein isolate (Elmsland group), potato protein isolate (Avebe), Augeo (Solvay)

### 1.1 Whey Protein/Alginate Hybrid Aerogel

Solution 1: Whey protein was dissolved in water at room temperature at 20 wt.-%.
Solution 2: Sodium alginate was dissolved in water at room temperature at 2 wt. %.
Solution 3: Aqueous CaCl₂) (20 g/L) was prepared at room temperature.
Solutions 1 and 2 were combined at a weight ratio of whey protein and sodium alginate 95:5 and a total concentration of 15 wt. %. pH was adjusted to ˜7 with NaOH to obtain solution 4.
Solution 4 was dropped into solution 3 (10× volume) with a pipette. Hydrogel particles formed and settled to the bottom of solution 3.
The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).
The alcogel particles were dried with supercritical carbon dioxide at 60° C., 120 bar, 1 h to obtain whey protein/alginate hybrid aerogel particles.
Bulk density of the aerogel particles was ˜150 g/l.
Surface area of the aerogel particles was determined to be 139 m²/g.
   1.2 Hybrid Aerogels with Various Biopolymers
Solution 1: Microcrystalline cellulose, sodium caseinate, tannic acid, potato starch or gelatin were blended with 2 wt. % sodium alginate solution to obtain various solutions with concentration and weight ratio as shown in Table 2. In the case of potato starch, a dispersion of potato starch was heated to 90° C. before blending for dissolution. In the case of gelatin, a gelatin dispersion was heated to 80° C. before blending for dissolution. In the case of microcrystalline cellulose (MCC), 6 g of MCC was added to 94 g of 8 wt. % NaOH under stirring at −8° C., and the resulting mixture was left to stand at 4° C. for 24 h. 40 wt. % NaOH was added to various solutions until the pH shown in Table 2 was obtained.
Solution 2: Aqueous CaCl₂) (10 g/L) was prepared at room temperature and adjusted to pH10 with 1M NaOH.
Solution 1 was dropped into solution 2 (10× volume) with a pipette. Hydrogel particles formed and settled to the bottom of solution 2.
The hydrogel particles were immersed in ethanol (93%, 10× volume) for 5 min. A final solvent exchange step was performed by immersing the gel particles from the previous step in pure ethanol (10× volume) for 5 min to obtain alcogel particles (final solvent concentration 94-98%).
The alcogel particles were dried with supercritical carbon dioxide at 60° C., 120 bar, 1 h to obtain hydrophilic hybrid aerogel particles with bulk density and surface area as shown in Table 2.
For hydrophobization, 50 ml hydrophilic aerogel particles were placed in a filter bag in a 2 l reactor. 50 ml HMDZ were also placed in the reactor in a small, open container. The reactor was closed and heated to 115° C. After 20 h, the reactor was cooled down to room temperature, and hydrophobic aerogel particles with a surface area as shown in Table 1 were removed from the reactor.

TABLE 1

| | | | | | | | | Aerogel surface |
|---|---|---|---|---|---|---|---|---|
| | | | | | | Aerogel | Aerogel | area after |
| | | | | | | bulk | surface | hydro- |
| | | | | | | density | area | phobization |
| 1 | C1 | wt. % | C2 | wt. % | pH | g/l | m²/g | m²/g |
| 2 | MCC | 4.0% | Na | 1.0% | 13 | 43 | 339 | 233 |
| | | | alginate | | | | | |
| 3 | Sodium | 5.9% | Na | 1.0% | 11 | 68 | 145 | 129 |
| | caseinate | | alginate | | | | | |
| 4 | Tannic | 5.9% | Na | 1.0% | 11.5 | 85 | 128 | 110 |
| | acid | | alginate | | | | | |
| 5 | Potato | 4.3% | Na | 1.0% | not | 46 | 187 | 176 |
| | starch | | alginate | | adjusted | | | |
| 6 | Gelatin | 5.9% | Na | 1.0% | not | 47 | 255 | 241 |
| | | | alginate | | adjusted | | | |

### 2. Preparation Hybrid Aerogels

Biopolymer A and biopolymer B were dissolved in water at target ratio and weight concentration as shown in Table 1 using a blender. The obtained solution was dripped into the double volume of 50 g/l polyvalent metal salt solution at room temperature using a syringe needle connected to a pump and reservoir to obtain hydrogel beads (syringe needle diameter adjusted to hydrogel particle diameter d 2 mm). The obtained hydrogel beads were cured in the gelation bath for 2 h at room temperature. The hydrogel bead shape was evaluated qualitatively for roundness and gel integrity. The diameter do of 10 hydrogel beads was measured and the average taken. The hydrogel beads were washed with water, and the water was successively exchanged to >98% ethanol in 3 steps to obtain alcogel beads. The alcogel beads were dried using supercritical CO₂ to obtain aerogel beads. The diameter dₑ of 10 aerogel beads was measured, the average taken and the shrinkage calculated.
The stability of the beads and loading were tested. The results are shown in Tables 2a and 2b.

TABLE 2a

| | 7 | 8 | 9 | 10 | 11 | 12 | 13 |
|---|---|---|---|---|---|---|---|
| Total conc. | 5 wt % | 5 wt % | 5 wt % | 5 wt % | 5 wt % | 5 wt % | 5 wt % |
| comp. A + B in | | | | | | | |
| hydrogel | | | | | | | |
| Comp. A | Whey | Whey | Whey | Whey | Whey | Pea | Potato |
| | protein | protein | protein | protein | protein | protein | protein |
| | | | | | | isolate | isolate |
| Content comp. A | 65% | 80% | 65% | 65% | 65% | 65% | 65% |
| Comp. B | SA | SA | SA | CMC | CMC | SA | SA |
| Content comp. B | 35% | 20% | 35% | 35% | 35% | 35% | 35% |
| Gelation bath | CaCl2 | CaCl2 | AlCl3 | AlCl3 | FeCl3 | CaCl2 | CaCl2 |
| Hydrogel | Good | Good | Good | Good | Good | Good | Good |
| quality | (round | (round | (round | (round | (round | (round | (round |
| | beads), | beads), | beads), | beads), | beads), | beads), | beads), |
| | colorless | colorless | colorless | colorless | reddish | pale | pale |
| | | | | | brown | yellow | brown |
| Aerogel | Not dusty | Not dusty | Not dusty | Not dusty | Not dusty | Not dusty | Not dusty |
| dustiness | | | | | | | |
| Bulk density g/l | ~60 | ~60 | ~60 | ~190 | ~100 | ~70 | ~60 |
| Aerogel | Good | Good | Good | Very good | Very good | Good | Good |
| shrinkage due | (~60%) | (~60%) | (~50%) | (~10%) | (~10%) | (~60%) | (~60%) |
| to humidity | | | | | | | |
| uptake | | | | | | | |
| Ethanol loading | Good | Good | Still good | Still good | Good | Good | Good |
| | (<10% | (<10% | (<10% | (<10% | (<10% | (<10% | (<10% |
| | shrinkage | shrinkage | shrinkage, | shrinkage, | shrinkage | shrinkage | shrinkage |
| | and not | and not | but easily | but easily | and not | and not | and not |
| | easily | easily | crushed) | crushed) | easily | easily | easily |
| | crushed) | crushed) | | | crushed) | crushed) | crushed) |
| Augeo loading | Good | Good | Still good | Still good | Good | Good | Good |
| | (<10% | (<10% | (<10% | (<10% | (<10% | (<10% | (<10% |
| | shrinkage | shrinkage | shrinkage, | shrinkage, | shrinkage | shrinkage | shrinkage |
| | and not | and not | but easily | but easily | and not | and not | and not |
| | easily | easily | crushed) | crushed) | easily | easily | easily |
| | crushed) | crushed) | | | crushed) | crushed) | crushed) |
| Oil loading | Good | Good | Still good | Still good | Good | Good | Good |
| | (<10% | (<10% | (<10% | (<10% | (<10% | (<10% | (<10% |
| | shrinkage | shrinkage | shrinkage, | shrinkage, | shrinkage | shrinkage | shrinkage |
| | and not | and not | but easily | but easily | and not | and not | and not |
| | easily | easily | crushed) | crushed) | easily | easily | easily |
| | crushed) | crushed) | | | crushed) | crushed) | crushed) |

TABLE 2b

| | Comparative | Comparative | Comparative | Comparative | Comparative | Comparative |
|---|---|---|---|---|---|---|
| | example 1 | example 2 | example 3 | example 4 | example 5 | example 6 |
| Total conc. | 5 wt % | 5 wt % | 3 wt % | 3 wt % | 5 wt % | 5 wt % |
| comp. A + B in | | | | | | |
| hydrogel | | | | | | |
| Comp. A | Whey protein | Whey protein | — | — | — | — |
| Content comp. A | 100% | 100% | — | — | — | — |
| Comp. B | — | — | SA | SA | SA | SA |
| Content comp. B | — | — | 100% | 100% | 100% | 100% |
| Gelation bath | CaCl2 | AlCl3 | CaCl2 | AlCl3 | CaCl2 | AlCl3 |
| Hydrogel | No gel formed | No gel formed | Good (round | Good (round | Solution too | Solution too |
| quality | | | beads) | beads) | viscous | viscous |
| Aerogel | — | — | Not dusty | Not dusty | — | — |
| dustiness | | | | | | |
| Bulk density g/l | — | — | ~40 | ~30 | — | — |
| Aerogel | — | — | Bad (>70%) | Bad (>70%) | — | — |
| shrinkage due | | | | | | |
| to humidity | | | | | | |
| uptake | | | | | | |
| Ethanol loading | — | — | Good (<10% | Good (<10% | — | — |
| | | | shrinkage and | shrinkage and | | |
| | | | not easily | not easily | | |
| | | | crushed) | crushed) | | |
| Augeo loading | — | — | Good (<10% | Good (<10% | — | — |
| | | | shrinkage and | shrinkage and | | |
| | | | not easily | not easily | | |
| | | | crushed) | crushed) | | |
| Oil loading | — | — | Good (<10% | Good (<10% | — | — |
| | | | shrinkage and | shrinkage and | | |
| | | | not easily | not easily | | |
| | | | crushed) | crushed) | | |

### 3. Methods Used

3.1 Pore volume was measured according to DIN 66134:1998-02 using a Nova 4000e pore size analyzer from Quantachrome Instruments. Approximately 15-20 mg of the samples were broken off from the original sample and placed in a measuring glass cell. The samples were degassed under 50 mm Hg vacuum and 60° C. for 15 h to remove any adsorbed components on the sample. The samples were weighed again prior to the surface area and pore size analysis.
3.2 Surface area measurements: Specific surface area was determined by Brunauer-Emmet-Teller (BET) method using low-temperature nitrogen adsorption analysis (at the boiling point of nitrogen, 77K) between the IUPAC recommended P/P0 range (0.05-0.30). The 1/((w.(P0/P−1))) vs P/P0 graph yielded linear plot with correlation coefficients (r) above 0.999.
3.3 Humidity test: 5 ml of aerogel beads were placed in a petri dish. The diameter do of 10 aerogel beads was measured and the average taken. The aerogel beads were exposed to a relative humidity of 60% for 48 hours at 30° C. The diameter dₑ of 10 aerogel beads was measured, the average taken and the shrinkage calculated.
3.4 Loading of liquid: 5 ml of aerogel beads were placed into a glass vial. The diameter do of 10 beads was measured and the average taken. The liquid or liquefied organic solvent or oil was dripped onto the beads in steps of 3-4 drops, softly agitating the beads every few drops to spread the active, and the addition was stopped as soon as supernatant liquid was observed. The diameter dₑ of 10 loaded beads was measured the average taken, and the shrinkage calculated. The mechanical resilience was evaluated by compression between two fingers.
The shrinkage was calculated as S=(dₑ−d₀)/d₀, where d₀ is the initial bead diameter and dₑ is the final bead diameter.

### LITERATURE CITED

Journal of Supercritical Fluids 2015, 105, 1-8
US20190329208A1
Grishechko, L. et al. Industrial Crops and Products, 41 (2013) 347-355
Partap et al. (2006, “Supercritical Carbon Dioxide in Water” Emulsion-Templated Synthesis of Porous Calcium Alginate Hydrogels. Advanced Materials 18, 501-50
WO 2016032733A2
WO 2019167013A1
EP 3741794A1
EP 2663395B1
CN 114958480A
WO 2018056652A
WO 2017023702A1
Budtova et al. (Cellulose 2019, 26, 81-121 (10.1007/s10570-018-2189-1
CN 105601983B
WO 2019190379A1
WO 96/25950 A1
WO 9501165A1
WO 2009062975A1
WO 02051389A2
WO 2009/027310
Robitzer et al., 2008, Langmuir, 24 (21), 12547-12552

1. A process for preparing a porous material, the process at least comprising:
a providing a mixture (M1) comprising at least one compound (C1) selected from the group consisting of bio-based polymers, at least one polyionic biopolymer as component (C2), and water,
b) bringing mixture (M1) into contact with an aqueous solution of a polyvalent metal ion to prepare a gel (A),
c) exposing the gel (A) obtained in b) to a water miscible solvent (L) to obtain a gel (B),
d) drying of the gel (B) obtained in c).

2. The process according to claim 1, wherein compound (C1) is a protein.

3. The process according to claim 1, wherein compound (C2) is a polyanionic biopolymer.

4. The process according to claim 1, wherein the mixture (M1) comprises compound (C1) in an amount of 0.1% by weight to 50% by weight based on a weight of mixture (M1).

5. The process according to claim 1, wherein mixture (M1) comprises compound (C1) and compound (C2) in a ratio in a range of from 55:45 to 98:2.

6. The process according to claim 1, wherein the process comprises one or more further modifications of the dried gel.

7. The process according to claim 1, wherein the solvent (L) used in c) is selected from the group consisting of C₁ to C₆ alcohols, C₁ to C₆ ketones, and mixtures thereof.

8. The process according to claim 1, wherein a water insoluble solid (S) is brought into contact with mixture (M1).

9. The process according to claim 1, wherein a compound (C) is added to mixture (M1), wherein the compound (C) is selected from the group consisting of pigments, opacifiers, flame retardants, catalytic materials, metals, metal oxides, metal sulfides, metal carbides, metal salts, silicon-based materials, carbon-based materials, metal-organic frameworks, semiconductors, sulfur, fillers, surface-active substances, heat control member, fibers and foam reinforcement.

10. A porous material, which is obtained or obtainable by the process according to claim 1.

11. The porous material according to claim 10, wherein a specific surface area of the porous material is in a range of from 200 to 800 m²/g, determined using the BET theory according to DIN 66134:1998-0 and a pore volume is in a range of from 2.1 to 9.5 cm³/g for pore sizes<150 nm.

12. The porous material according to claim 10, wherein a content of volatile organic compounds (VOC) in the porous material is less than 50% of a content of volatile organic compounds (VOC) in the starting materials used in the process.

13. The porous material according to claim 10, wherein the porous material is bead shaped.

14. A carrier material or adsorbent, comprising:
the porous material according to claim 10.

15. A method, comprising:
forming a product with the porous material according to claim 10 wherein the product is selected from the group consisting of thermal insulation material, carrier material for load and release of actives, battery applications, electrode materials in batteries, fuels cells or electrolysis, catalysts, capacitors, consumer electronics, building and construction applications, home and commercial appliance applications, temperature-controlled logistics applications, vacuum insulation applications, apparel applications, food applications, cosmetic applications, biomedical applications, agricultural applications, consumer applications, packaging applications and pharmaceutical applications.

16. The process according to claim 2, wherein compound (C1) is a whey protein.

17. The process according to claim 3, wherein compound (C2) is a polyanionic biopolymer selected from the group consisting of alginates, pectin, and modified cellulose.

18. The process according to claim 6, wherein the modification is selected from the group consisting of shaping, compression, lamination, post-drying, hydrophobization, and carbonization.

19. The porous material according to claim 13, wherein the porous material has an average diameter in a range of 0.5 mm to 3 mm.
